(19) United States
(12) Patent Application Publication
(10) Pub. No.: US 2015/0339053 A1
(43) Pub. Date: Nov. 26, 2015

(54) APPARATUS AND METHOD FOR CREATING INPUT VALUE ON VIRTUAL KEYBOARD

(71) Applicant: ELECTRONICS AND TELECOMMUNICATIONS RESEARCH INSTITUTE, Daejeon (KR)

(72) Inventors: Yongdae KIM, Daejeon (KR); Haeng Seok KO, Daejeon (KR); Sangwoo PARK, Daejeon (KR); Hyuk Joong YOON, Daejeon (KR); Hee Bong CHOI, Daejeon (KR)

(21) Appl. No.: 14/471,939

(22) Filed: Aug. 28, 2014

(30) Foreign Application Priority Data
May 20, 2014 (KR) 10-2014-0060194

(51) Int. Cl. G06F 3/0488; G06F 3/0484

(52) U.S. Cl. CPC G06F 3/04886; G06F 3/04842

(57) ABSTRACT

An apparatus and a method for creating an input value which a user intends to input on a virtual keyboard having a user-friendly key arrangement are disclosed. The method for creating an input value on a virtual keyboard includes: creating the virtual keyboard corresponding to a key arrangement of a user terminal; setting a position of a start key on the virtual keyboard; sensing that a user clicks the start key; confirming a moving distance of a user's hand from the start key; and creating an input key value which the user intends to finally input using the moving distance and the position of the start key.

### CROSS REFERENCE TO RELATED APPLICATION

This application claims the benefit of Korean Patent Application No. 10-2014-060194, filed on May 20, 2014, which is hereby incorporated by reference in its entirety into this application.

### BACKGROUND OF THE INVENTION

1. Technical Field

The present invention relates to an apparatus and a method for creating an input value on a virtual keyboard, and more particularly, to an apparatus and a method for creating an input value which a user intends to input on a virtual keyboard having a user-friendly key arrangement.

2. Description of the Related Art

With the propagation of a smart phone, a user is used to environment without a hardware keyboard.

For example, Korean Patent Laid-Open Publication No. 10-2011-0101030 entitled “Security Method Of Information By The Touch Screen” discloses a security method of information input of a touch screen which is an input device applied to various portable terminals (mobile phones), a general desktop type of computer, ATM used as an unmanned terminal in various financial companies, and the like.

As such, in order to prevent keyboard hooking and the like, Internet sites requiring security such as finance use a virtual keyboard rather than using an input to the keyboard to induce a key input (for example, password number, and the like).

As such, various key input methods using the virtual keyboard have been proposed. However, the virtual keyboard considerably differs from an input pattern (arrangement) of the keyboard generally used by the user, and therefore time required for the key input may be increased. Further, owing to the development of a timing attack, and the like inferring a key value by measuring each key input with the gradual development of a technology, a need exists for a virtual keyboard technology requiring high security.

### SUMMARY OF THE INVENTION

Accordingly, the present invention has been made keeping in mind the above problems occurring in the conventional art, and an object of the present invention is to provide an apparatus and a method for creating an input value which a user intends to input on a virtual keyboard having a user-friendly key arrangement.

In accordance with an aspect of the present invention, there is provided a method for creating an input value on a virtual keyboard, the method including: creating the virtual keyboard corresponding to a key arrangement of a user terminal; setting a position of a start key on the virtual keyboard; sensing that a user clicks the start key; confirming a moving distance of a user's hand from the start key; and creating an input key value which the user intends to finally input using the moving distance and the position of the start key.

In the determining the moving distance, after the user clicks the start key and the user's hand moves up to an input key which the user intends to input, the moving distance corresponding to a released result may be confirmed.

In the determining the moving distance, the moving distance including an X-axis moving distance and a Y-axis moving distance of a keypad included in the virtual keyboard from the start key may be confirmed.

In the creating of the virtual keyboard, the virtual keyboard including the same keypad as the key arrangement of the user terminal at a set ratio or more may be created.

In the setting, the set position of the start key may be displayed to the user.

In accordance with another aspect of the present invention, there is provided an apparatus for creating an input value on a virtual keyboard, the apparatus including: a virtual keypad creation unit configured to create the virtual keyboard corresponding to a key arrangement of a user terminal; a start key setting unit configured to set a position of a start key on the virtual keyboard; a click sensing unit configured to determine whether a user clicks the start key or not; a moving distance confirmation unit configured to determine a moving distance of a user's hand from the start key; and an input value creation unit configured to create an input key value which the user intends to finally input using the moving distance and the position of the start key.

The moving distance confirmation unit may determine the moving distance corresponding to a released result after the user clicks the start key and the user's hand moves up to an input key which the user intends to input.

The moving distance confirmation unit may determine the moving distance including an X-axis moving distance and a Y-axis moving distance of a keypad included in the virtual keyboard from the start key.

The start key setting unit may display the set position of the start key to the user.

The virtual keypad creation unit may create the virtual keyboard including the same keypad as the key arrangement of the user terminal at a set ratio or more.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram schematically illustrating an apparatus for creating an input value on a virtual keyboard according to an exemplary embodiment of the present invention;

FIGS. 2 to 4 are reference diagrams of the apparatus for creating an input value on a virtual keyboard according to the exemplary embodiment of the present invention; and

FIG. 5 is a flow chart illustrating a method for creating an input value on a virtual keyboard according to an exemplary embodiment of the present invention.

### DESCRIPTION OF THE PREFERRED EMBODIMENTS

Exemplary embodiments of the present invention will be described in detail with reference to the accompanying drawings. In the present specification, an overlapped description and a detailed description for well-known functions and configurations that may obscure the gist of the present invention will be omitted. Preferred embodiments of the present invention are provided in order to more completely explain the present invention to those skilled in the art. Therefore, throughout the accompanying drawings, shapes, sizes, and the like, of components may be exaggerated for clarity.

Hereinafter, an apparatus and a method for creating an input value on a virtual keyboard according to an exemplary embodiment of the present invention will be described with reference to the accompanying drawings.

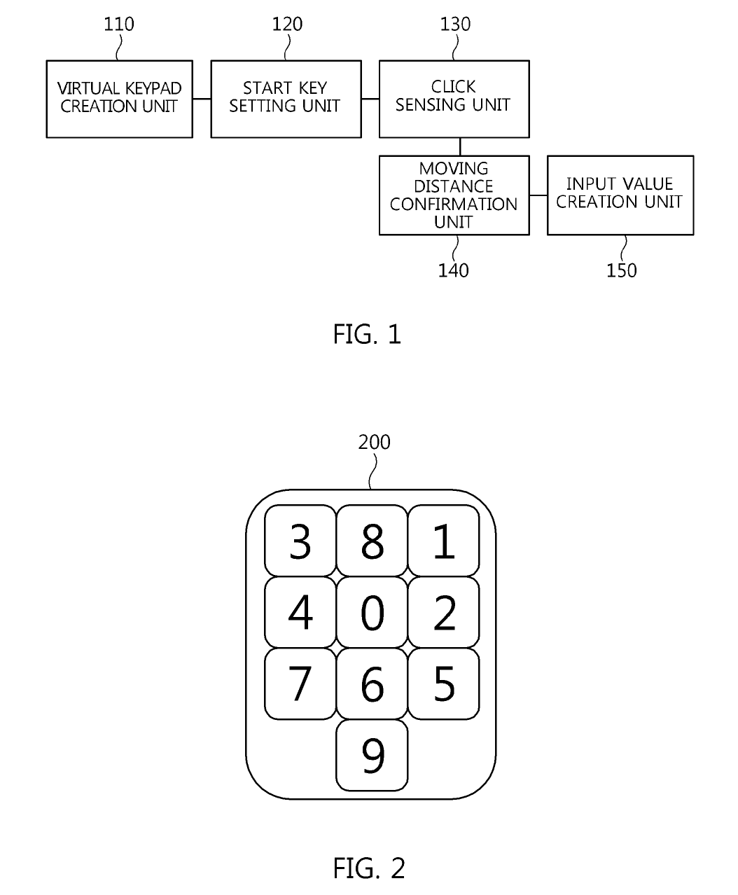

FIG. 1 is a configuration diagram schematically illustrating an apparatus for creating an input value on a virtual keyboard according to an exemplary embodiment of the present invention. Further, FIGS. 2 to 4 are reference diagrams of the apparatus for creating an input value on a virtual keyboard according to the exemplary embodiment of the present invention.

Referring to FIG. 1, the apparatus for creating an input value on a virtual keyboard includes a virtual keyboard creation unit 110, a start key setting unit 120, a click sensing unit 130, a moving distance confirmation unit 140, and an input value creation unit 150.

The virtual keypad creation unit 110 creates a virtual keyboard which includes a general hardware keyboard of a user terminal or a keypad having the same arrangement as a user-friendly key arrangement. In this case, the virtual keypad creation unit 110 may be set to create the virtual keyboard including the same keypad as the key arrangement of the user terminal at a set ratio or more, but is not limited thereto.

For example, the virtual keypad creation unit 110 may create the virtual keyboard having a form like reference numeral 200 of FIG. 2, but is not limited thereto.

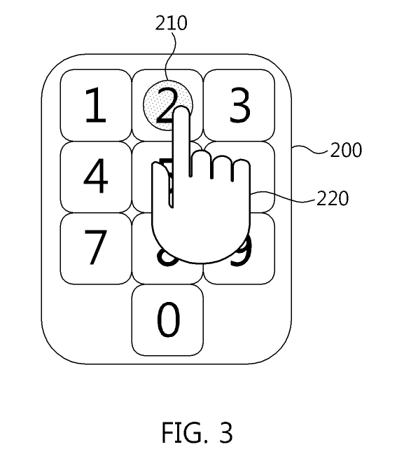

The start key setting unit 120 sets a position of a start key 210 (FIG. 3) on the virtual keyboard 200 (FIG. 3) created in the virtual keypad creation unit 110 and displays the set position of the start key.

The user clicks the start key 210 (FIG. 3) displayed on the start key setting unit 120 and performs a release after his/her hand 220 (FIG. 3) (or mouse) moves up to a user desired key value (letter, figure, and the like on the virtual keyboard).

The click sensing unit 130 senses the user's click on the start key. The click sensing unit 130 determines whether the user clicks the start key set by the start key setting unit 120 or not.

The moving distance confirmation unit 140 determines a moving distance of the user's hand from the start key.

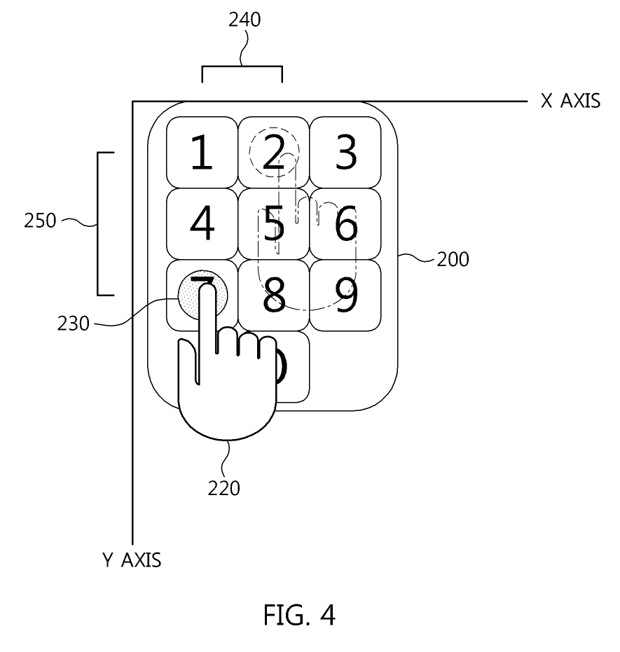

Referring to FIG. 4, when the user desired key value is “7”, the user moves his/her hand 220 in the state in which the user clicks from the start key 210 to “7” 230 to perform the release. In this case, the moving distance of the user's hand 220 includes an X-axis moving distance 240 and a Y-axis moving distance 250.

The input value creation unit 150 uses the moving distance and the position of the start key which are confirmed by the moving distance confirmation unit 140 to create the input key value which the user intends to finally input.

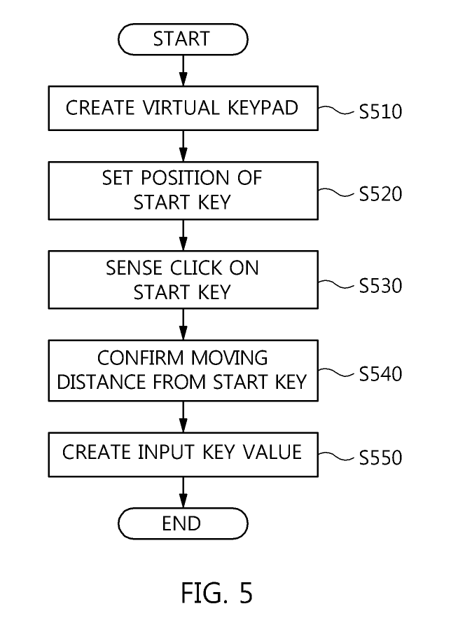

Next, the method for creating an input value on a virtual keyboard will be described in detail with reference to FIG. 5.

FIG. 5 is a flow chart illustrating a method for creating an input value on a virtual keyboard according to an exemplary embodiment of the present invention.

Referring to FIG. 5, the apparatus for creating an input value on a virtual keyboard creates the virtual keyboard which includes the general hardware keyboard of the user terminal or the keypad having the same arrangement as the user-friendly key arrangement (S510). For example, in S510, the apparatus for creating an input value on a virtual keyboard may create the virtual keyboard having the form like reference numeral 200 of FIG. 2, but is not limited thereto.

The apparatus for creating an input value on a virtual keyboard sets the position of the start key 210 (FIG. 3) on the created virtual keyboard 200 (FIG. 3) (S520) and displays the set position of the start key.

The apparatus for creating an input value on a virtual keyboard determines whether the user clicks the start key set in S520 (S530). In this case, the user clicks the start key 210 (FIG. 3) displayed on the virtual keyboard and performs the release after his/her hand 220 (FIG. 3) (or mouse) moves up to the user desired key value (letter, figure, and the like on the virtual keyboard).

The apparatus for creating an input value on a virtual keyboard determines the moving distance of the user's hand from the start key sensed in S530 (S540). Referring to FIG. 4, the moving distance of the user's hand 220 may be represented by the X-axis moving distance 240 and the Y-axis moving distance 250, but is not limited thereto.

The apparatus for creating an input value on a virtual keyboard uses the moving distance and the position of the start key which are confirmed in S540 to create the input key value which the user intends to finally input (S550).

As described above, according to the exemplary embodiments of the present invention, the method for creating an input value on a virtual keyboard does not use the click value on the virtual keyboard having the user-friendly key arrangement but uses the release event of the click after the user presses the mouse button to create the input key value which the user intends to input, thereby increasing the efficiency of the key input, preventing the timing attack, and the like.

According to the exemplary embodiments of the present invention, the input key value which the user intends to input may be created using the release event of the click after the user presses the mouse button, not using the click value on the virtual keyboard having the user-friendly key arrangement, thereby increasing the efficiency of the key input, preventing the input key value from being leaked due to the screen capture the click type, and the like.

The optimal exemplary embodiments are disclosed above in the drawings and the specification. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method for creating an input value on a virtual keyboard, the method comprising:
creating the virtual keyboard corresponding to a key arrangement of a user terminal;
setting a position of a start key on the virtual keyboard;
determining whether a user clicks the start key or not;
determining a moving distance of a user's hand from the start key; and
creating an input key value which the user intends to finally input using the moving distance and the position of the start key.

2. The method of claim 1, wherein the determining the moving distance determines the moving distance corresponding to a release after the user clicks the start key and the user's hand moves up to an input key which the user intends to input.

3. The method of claim 1, wherein the determining the moving distance determines the moving distance including an X-axis moving distance and a Y-axis moving distance of a keypad included in the virtual keyboard from the start key.

4. The method of claim 1, wherein the creating of the virtual keyboard creates the virtual keyboard including the same keypad as the key arrangement of the user terminal at a set ratio or more.

5. The method of claim 1, wherein the setting the position displays the set position of the start key to the user.

6. An apparatus for creating an input value on a virtual keyboard, the apparatus comprising:
a virtual keypad creation unit configured to create the virtual keyboard corresponding to a key arrangement of a user terminal;
a start key setting unit configured to set a position of a start key on the virtual keyboard;
a click sensing unit configured to determine whether a user clicks the start key or not;
a moving distance confirmation unit configured to determine a moving distance of a user's hand from the start key; and
an input value creation unit configured to create an input key value which the user intends to finally input using the moving distance and the position of the start key.

7. The apparatus of claim 6, wherein the moving distance confirmation unit determines the moving distance corresponding to a release after the user clicks the start key and the user's hand moves up to an input key which the user intends to input.

8. The apparatus of claim 6, wherein the moving distance confirmation unit determines the moving distance including an X-axis moving distance and a Y-axis moving distance of a keypad included in the virtual keyboard from the start key.

9. The apparatus of claim 6, wherein the start key setting unit displays the set position of the start key to the user.

10. The apparatus of claim 6, wherein the virtual keypad creation unit creates the virtual keyboard including the same keypad as the key arrangement of the user terminal at a set ratio or more.
